(19) United States
(12) Patent Application Publication
(10) Pub. No.: US 2026/0300009 A1
(43) Pub. Date: Oct. 1, 2026

(54) AGENTIC, GRAPH-BASED PLANNING AND EXECUTION FOR STRUCTURED TASK SOLVING

(71) Applicant: Cisco Technology, Inc., San Jose, CA (US)

(72) Inventors: Advit Deepak, San Jose, CA (US); Jayanth Srinivasa, Newark, CA (US); Ramana Rao V.R. Kompella, Foster City, CA (US)

(73) Assignee: Cisco Technology, Inc., San Jose, CA (US)

(21) Appl. No.: 19/091,592

(22) Filed: Mar. 26, 2025

(51) Int. Cl. G06F 9/50

(52) U.S. Cl. CPC G06F 9/5027

(57) ABSTRACT

In one implementation, a device receives a request for an agentic system comprising a plurality of artificial intelligence agents to complete a task. The device represents the task as a sink node in a graph and contextual information from the request as a source node in the graph. The device identifies a path in the graph from the sink node to the source node in part by recursively adding action nodes to the graph that represent potential actions that the agentic system could take. The device uses the path in a reverse direction from the source node to the sink node as an execution plan for the agentic system to complete the task.

### TECHNICAL FIELD

The present disclosure relates generally to artificial intelligence (AI)-based agents and, more particularly, to agentic, graph-based planning and execution for structured task solving.

### BACKGROUND

The recent breakthroughs in large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

However, there is often little to no visibility into the interactions between agents in a multi-agent system. Indeed, most agentic systems rely on loosely defined structures (e.g., group chat, manager workers, etc.), making their task executions non-interpretable (e.g., due to lengthy chats between agents, etc.). Additionally, task runs are independent of one another, due to the stochastic nature of LLMs.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIGS. 5A-5E illustrate an example of a graph-based approach to providing visibility into agentic systems; and

FIG. 6 illustrates an example simplified procedure for agentic, graph-based planning and execution for structured task solving, in accordance with one or more implementations described herein.

### DESCRIPTION OF EXAMPLE IMPLEMENTATIONS

### Overview

According to one or more implementations of the disclosure, a device receives a request for an agentic system comprising a plurality of artificial intelligence agents to complete a task. The device represents the task as a sink node in a graph and contextual information from the request as a source node in the graph. The device identifies a path in the graph from the sink node to the source node in part by recursively adding action nodes to the graph that represent potential actions that the agentic system could take. The device uses the path in a reverse direction from the source node to the sink node as an execution plan for the agentic system to complete the task.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

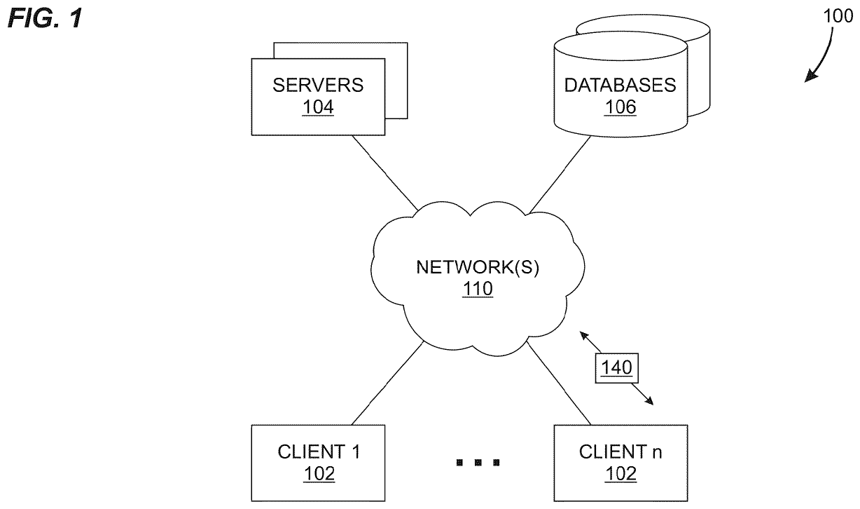

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

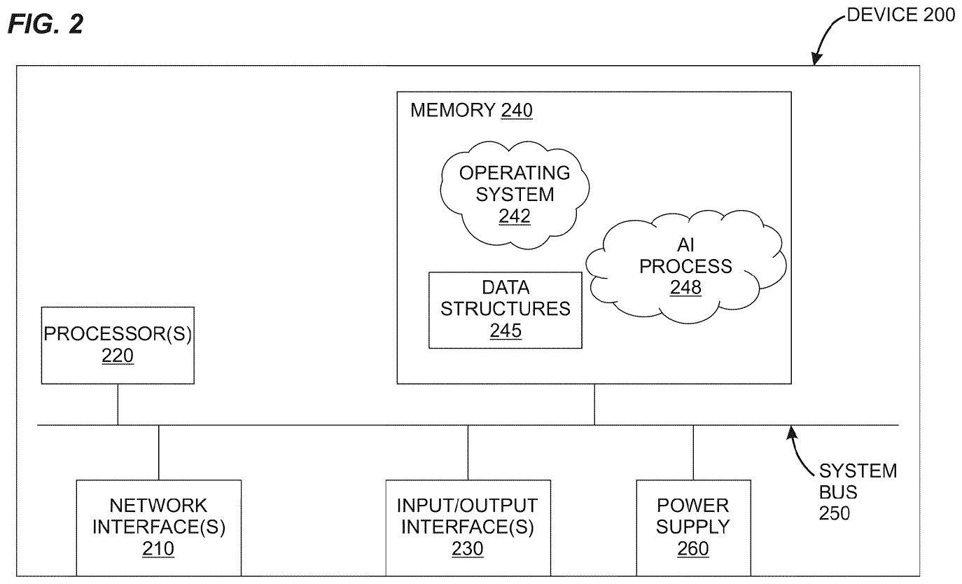

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

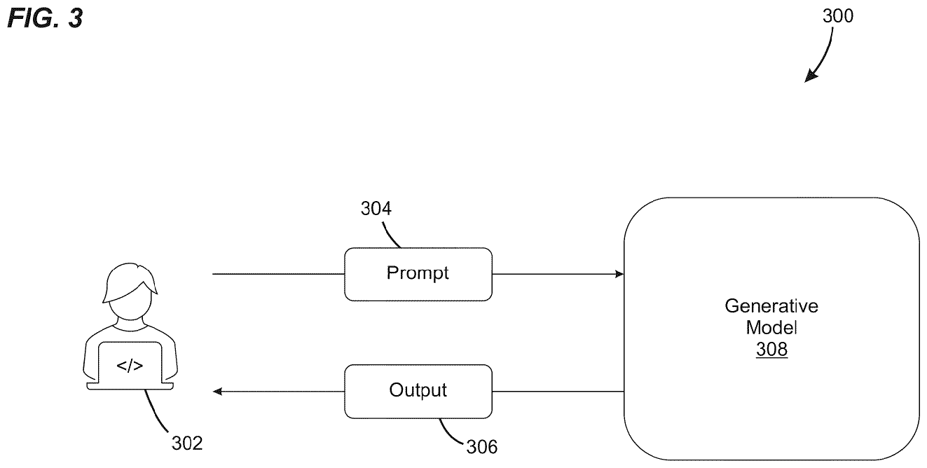

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

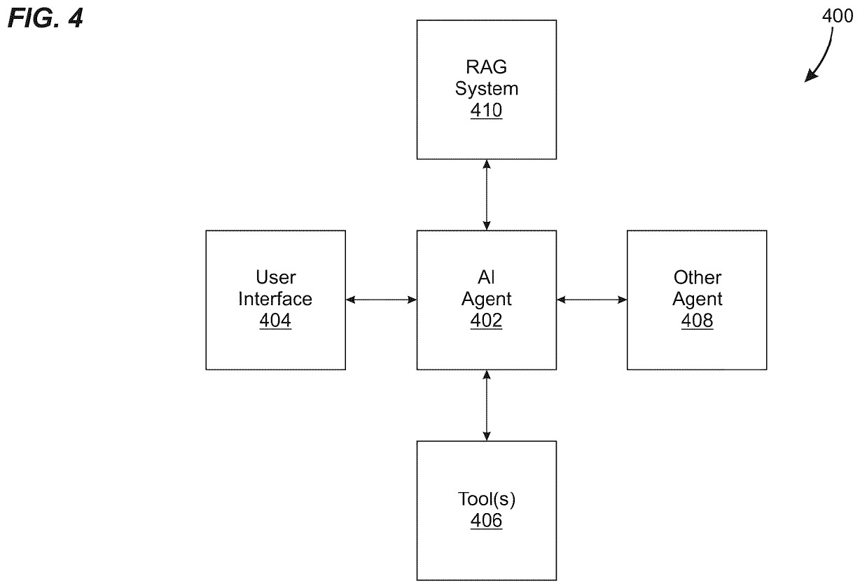

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, agentic systems present an evolution over singular AI-agents as they are able to perform complex tasks by chaining multiple calls to one or more LLMs. Indeed, agentic systems also allow for different AI-based agents to be specialized for different (sub)tasks. However, there is often little to no visibility into the interactions between agents in a multi-agent system. Indeed, most agentic systems rely on loosely defined structures (e.g., group chat, manager workers, etc.), making their task executions non-interpretable (e.g., due to lengthy chats between agents, etc.). Additionally, task runs are independent of one another, due to the stochastic nature of LLMs.

### Agentic, Graph-Based Planning and Execution for Structured Task Solving

The techniques herein introduce a graph-based planning and execution approach for structured task solving. Such an approach allows for reporting on the approach that the agentic system selects to complete a task, thereby affording users visibility into its operations.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device receives a request for an agentic system comprising a plurality of artificial intelligence agents to complete a task. The device represents the task as a sink node in a graph and contextual information from the request as a source node in the graph. The device identifies a path in the graph from the sink node to the source node in part by recursively adding action nodes to the graph that represent potential actions that the agentic system could take. The device uses the path in a reverse direction from the source node to the sink node as an execution plan for the agentic system to complete the task.

Operationally, to address the lack of visibility into agentic systems today, the techniques herein define three stages of operation of an agentic system: 1.) planning, 2.) execution, and 3.) compilation. With these stages in mind, the techniques herein introduce a graph-based approach for task execution in the agentic system that allows for greater visibility into its execution plan.

More specifically, during the planning stage, the agentic system may begin by specifying the following:
A source node that represents in the graph where the system can start from given provided context.
A sink node that represents in the graph where the system must end to successfully complete task.

In some implementations, the techniques herein may also represent each callable function/tool as a separate node in the graph. In such a case, an incoming edge to the node may represent the prerequisites for calling that function/tool, such as its input arguments. Similarly, an outgoing edge in the graph from that node may represent the output that the function/tool will return after being called.

In general, the ultimate goal of the agentic system is to find a path from the source node to the sink node by working backwards. To do so, the agentic system may keep track of what functions/tools have been tried, so as to avoid loops, and backtrack if stuck, to re-select potential functions/tools along the path. Accordingly, in various implementations, the planning stage may proceed as follows:
Populate the source node with the provided context
Starting at the sink node, while not at the source node, do the following:
   Find the most upper-level/last function that needs to be called to resolve the task (most general).
   For each required input parameter (argument) that's not at the source, recursively resolve this input parameter by calling other functions (e.g., the new objective is to find argument X_arg in order to call function X to solve TAKS) with appropriate analysis.

The result of the above approach is a chain of function/tool calls that are needed to perform the task.

In one implementation, to verify a potential task execution flow, the system may simulate calls to functions/tools, rather than directly executing them. Indeed, directly executing such calls can be computationally expensive as well as potentially dangerous to the data.

In a further implementation, the system may also identify information that the user or other requester must provide in order to resolve a task (e.g., there exists no tool that can return information for the critical path).

Once the system has an execution plan in place, it may transition to its execution phase and work its way through the graph from the source node to the sink node. At each node, it may execute the corresponding function/tool that it represents. The system may also continuously analyze the execution until the task is resolved.
Starting at the sink node, while not at the source node, do the following:
   Execute the following with the incoming argument(s)
   Analyze the output (reflect) and determine how to use the output along with previous outputs/source context to populate the argument(s) for the next node/function/tool

In various implementations, if the agentic system has successfully completed the desired task, it may then enter into its compilation phase. To do so, in some implementations, it may convert the underlying API calls and LLM-analysis into a generalized, reusable, low-LLM script (e.g., a Python script or the like). In turn, the system may register this new script as a callable method for future use.

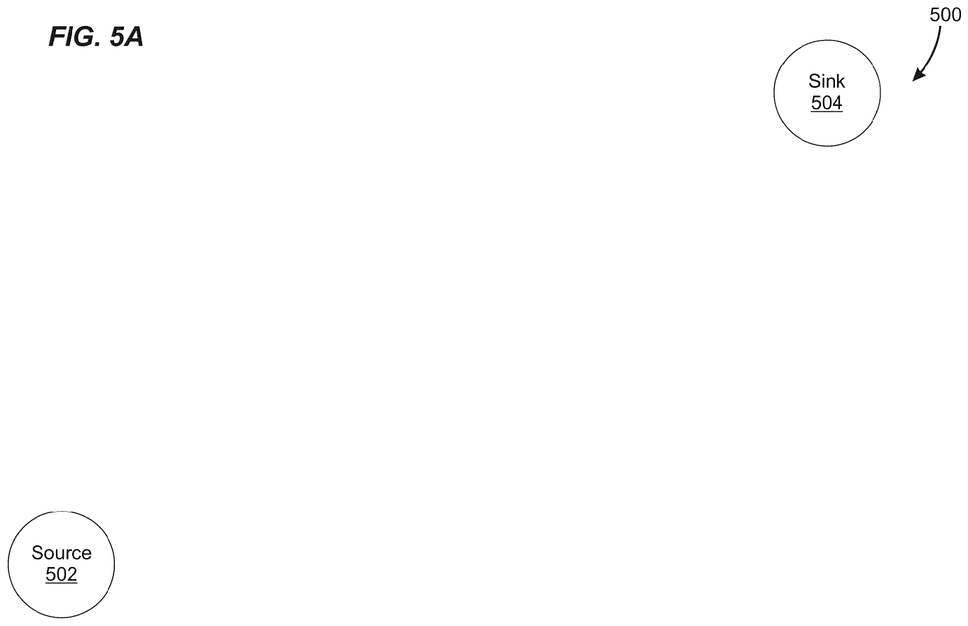

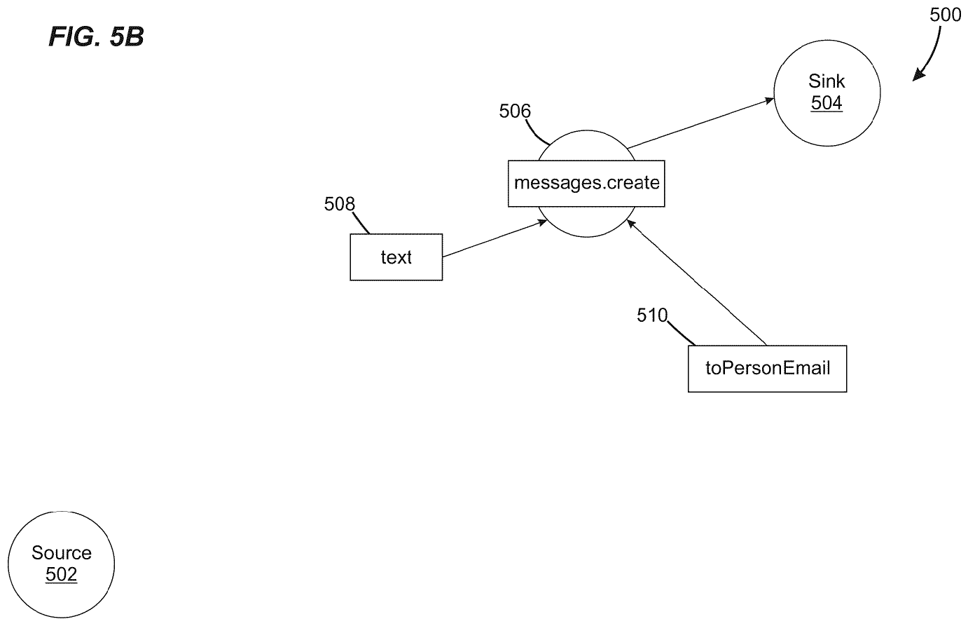

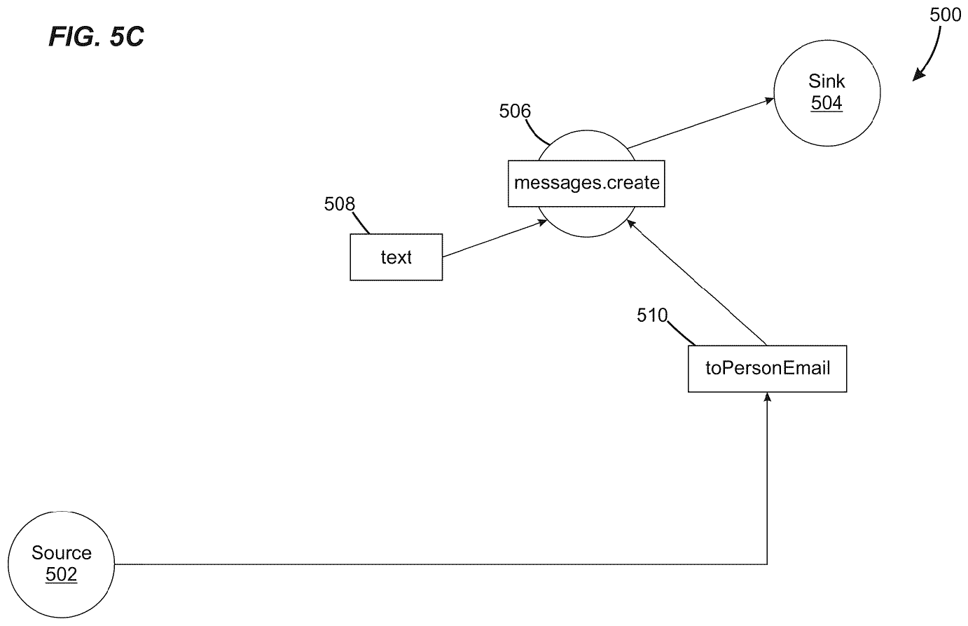

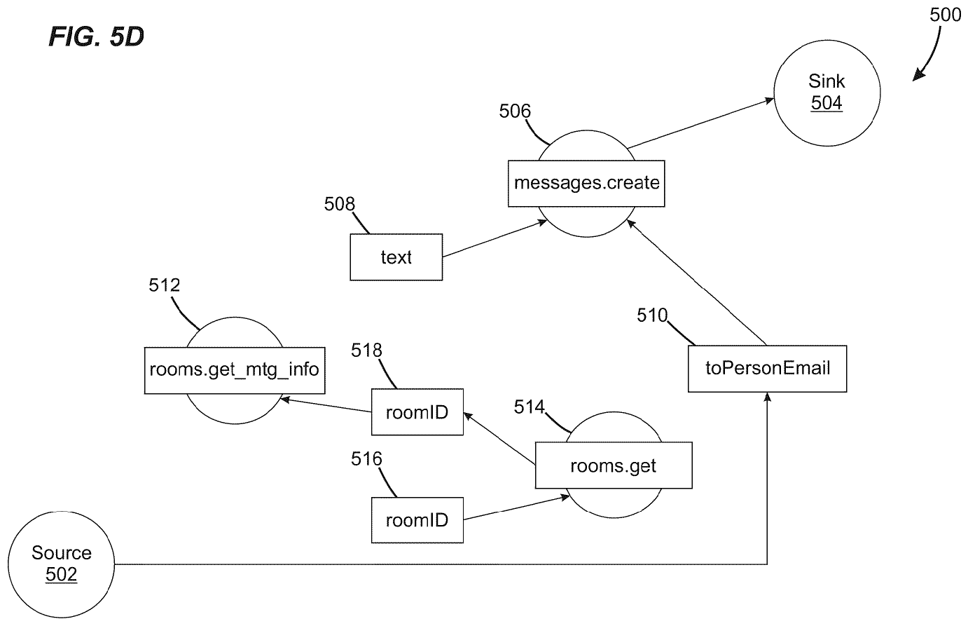

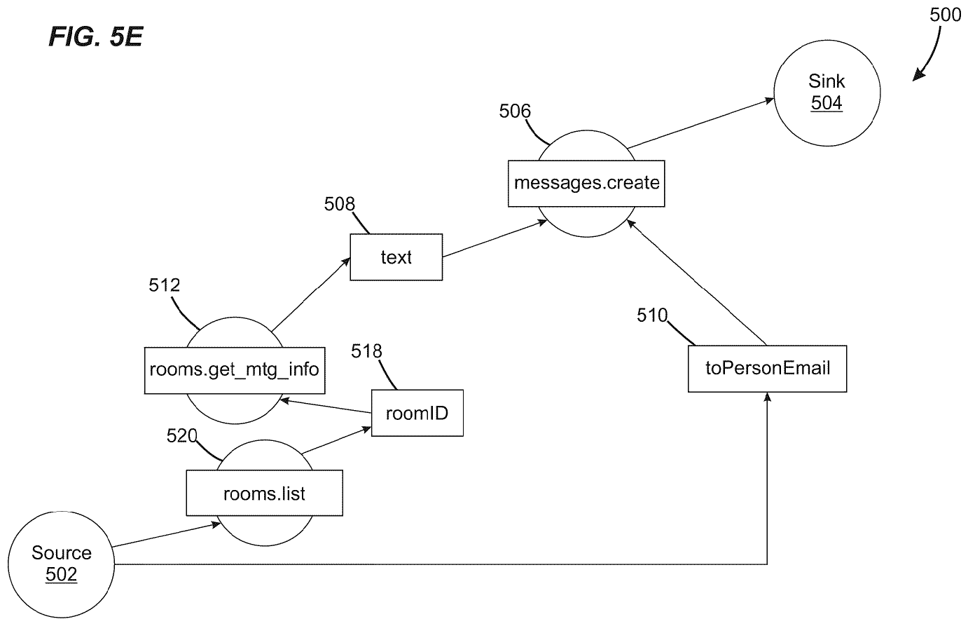

FIGS. 5A-5E illustrate an example 500 of a graph-based approach to providing visibility into agentic systems, in various implementations. For purposes of illustration, assume that the task is as follows: “find the meeting details for the Engineering group meeting and send it to user@company.foo via Webex.”

As shown in FIG. 5A, the system may begin by creating a source node 502 and a sink node 504. In accordance with the above approach, the source node 502 represents the source contextual information available to the system. Sink node 504, meanwhile, represents the desired state whereby the agentic system returns the desired meeting link for the specified videoconference.

In FIG. 5B, the system first identifies function messages. create that it represents as node 506. In addition, the system may identify the arguments needed to call that function. For instance, these arguments may include argument 510 (toPersonEmail) that specifies the email address to which the email message is to be sent. In addition, the function may also take as input argument 508, which specifies the text to be included in the body of the email.

In FIG. 5C, the system then connects source node 502 to argument 510. Here, the contextual information associated with source node 502 includes the target email address of user@company.foo. Doing so represents in the graph that the messages. create function should be called using that email address as its argument.

In FIG. 5D, the system then seeks to resolve input argument 508, that is, the text of the email to be sent. Here, retrieval of the meeting information may first require identifying the meeting room. To do so, the system may first identify the function, rooms.get_mtg_info, and represent it as node 512. This function requires the argument 518, roomID.

The system may then identify function rooms. get as a way to get argument 518, represented by node 514. This function likewise requires argument 516, roomID.

In FIG. 5E, the system may backtrack from argument 516 to identify the function rooms. list and represent it as node 520 in its graph. This function itself requires no arguments, but outputs the needed value for argument 518. Since rooms. get is not needed, the system may also remove node 514 from the graph.

As a result of this backtracking, the resulting graph shown in FIG. 5E may represent the execution graph needed to perform the desired task. In other words, to send the desired email with the meeting information to the specified user, the system may first make a call to the function rooms. list associated with node 520, to get the argument 518, roomID. In turn, it may use this argument to call rooms.get_mtg_info associated with node 512, to obtain the meeting information.

Using the retrieved meeting information as input argument 508, the system may then call messages. create associated with node 506, to send an email to the specified email address of argument 510. The result of this execution plan is the system sending an email to the email address with the meeting information. By taking this approach, the system could provide information regarding the execution plan/graph to a user interface, thereby allowing a user to review how the system completed the task.

As would be appreciated, the techniques herein are not limited to task solving, but could also be extended for other purposes. For instance, in one implementation, the techniques herein could also identify missing information in documentation. Indeed, by formulating an execution graph in the above manner, the constituent functions are often called in order. In such cases, the system could identify situations in which a new function should be created, whether a given function is often missing/user-dependent, or the like.

In a further implementation, the techniques herein may also allow developers to specify (e.g., using natural language) a task to be performed. In turn, the system may use the above techniques to identify, stitch, and execute the appropriate underlying API calls, as well as provide them to the user. Doing so allows for quick development/prototyping (planning/execution) while retaining the speed of non-agentic API calling for deployment (compilation).

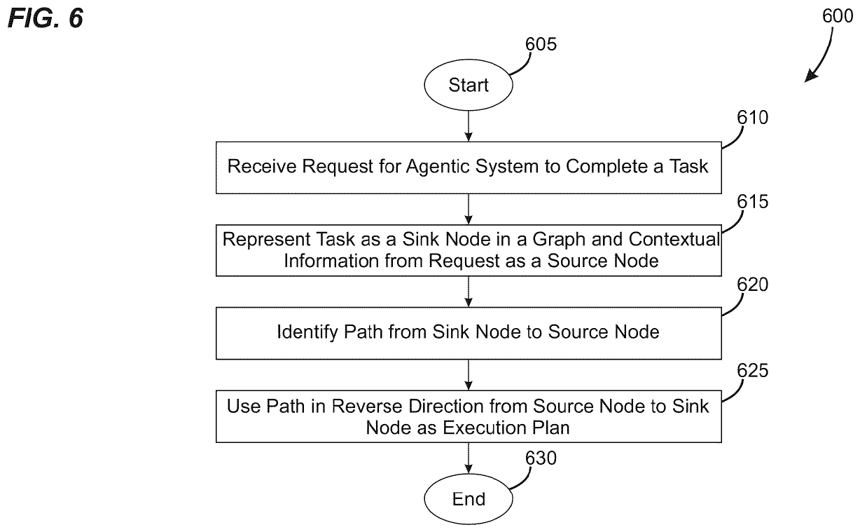

FIG. 6 illustrates an example simplified procedure for agentic, graph-based planning and execution for structured task solving, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, etc.) may receive a request for an agentic system comprising a plurality of artificial intelligence agents to complete a task. In some cases, the request is a natural language request. In one implementation, different artificial intelligence agents in the plurality of artificial intelligence agents are configured to perform different actions.

At step 615, as detailed above, the device may represent the task as a sink node in a graph and contextual information from the request as a source node in the graph. At step 620, the device may identify a path in the graph from the sink node to the source node in part by recursively adding action nodes to the graph that represent potential actions that the agentic system could take, as described in greater detail above. In some implementations, a potential action in the potential actions that the agentic system could take comprises an analysis request that a particular agent in the plurality of artificial intelligence agents could make to an artificial intelligence model. In one implementation, the artificial intelligence model comprises a large language model (LLM). In various implementations, a potential action in the potential actions that the agentic system could take comprises a call that a particular agent in the plurality of artificial intelligence agents could make to a function, application programming interface (API), or other agent in the plurality of artificial intelligence agents. In such cases, the device may recursively add action nodes to the graph in part by identifying one or more parameters needed for the particular agent to make the call and identifying one or more calls that could output those one or more parameters.

At step 625, as detailed above, the device may use the path in a reverse direction from the source node to the sink node as an execution plan for the agentic system to complete the task. In various implementations, the device may do so by using the path in the reverse direction to generate an executable script for execution by the agentic system. In such cases, the agentic system may use the executable script to address a subsequent request to perform the task again. In some implementations, the device may also a simulation of the agentic system using the execution plan.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for agentic, graph-based planning and execution for structured task solving, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
receiving, at a device, a request for an agentic system comprising a plurality of artificial intelligence agents to complete a task;
representing, by the device, the task as a sink node in a graph and contextual information from the request as a source node in the graph;
identifying, by the device, a path in the graph from the sink node to the source node in part by recursively adding action nodes to the graph that represent potential actions that the agentic system could take; and
using, by the device, the path in a reverse direction from the source node to the sink node as an execution plan for the agentic system to complete the task.

2. The method as in claim 1, wherein a potential action in the potential actions that the agentic system could take comprises an analysis request that a particular agent in the plurality of artificial intelligence agents could make to an artificial intelligence model.

3. The method as in claim 2, wherein the artificial intelligence model comprises a large language model (LLM).

4. The method as in claim 1, wherein the request is a natural language request.

5. The method as in claim 1, wherein a potential action in the potential actions that the agentic system could take comprises a call that a particular agent in the plurality of artificial intelligence agents could make to a function, application programming interface (API), or other agent in the plurality of artificial intelligence agents.

6. The method as in claim 5, wherein the device recursively adds action nodes to the graph in part by:
identifying one or more parameters needed for the particular agent to make the call; and
identifying one or more calls that could output those one or more parameters.

7. The method as in claim 1, further comprising:
initiating a simulation of the agentic system using the execution plan.

8. The method as in claim 1, wherein using the path in the reverse direction from the source node to the sink node as the execution plan for the agentic system to complete the task comprises:
using the path in the reverse direction to generate an executable script for execution by the agentic system.

9. The method as in claim 8, wherein the agentic system uses the executable script to address a subsequent request to perform the task again.

10. The method as in claim 1, wherein different artificial intelligence agents in the plurality of artificial intelligence agents are configured to perform different actions.

11. An apparatus, comprising:
one or more network interfaces;
a processor coupled to the one or more network interfaces and configured to execute one or more processes; and
a memory configured to store a process that is executable by the processor, the process when executed configured to:
receive a request for an agentic system comprising a plurality of artificial intelligence agents to complete a task;
represent the task as a sink node in a graph and contextual information from the request as a source node in the graph;
identify a path in the graph from the sink node to the source node in part by recursively adding action nodes to the graph that represent potential actions that the agentic system could take; and
use the path in a reverse direction from the source node to the sink node as an execution plan for the agentic system to complete the task.

12. The apparatus as in claim 11, wherein a potential action in the potential actions that the agentic system could take comprises an analysis request that a particular agent in the plurality of artificial intelligence agents could make to an artificial intelligence model.

13. The apparatus as in claim 12, wherein the artificial intelligence model comprises a large language model (LLM).

14. The apparatus as in claim 11, wherein the request is a natural language request.

15. The apparatus as in claim 11, wherein a potential action in the potential actions that the agentic system could take comprises a call that a particular agent in the plurality of artificial intelligence agents could make to a function, application programming interface (API), or other agent in the plurality of artificial intelligence agents.

16. The apparatus as in claim 15, wherein the apparatus recursively adds action nodes to the graph in part by:
identifying one or more parameters needed for the particular agent to make the call; and
identifying one or more calls that could output those one or more parameters.

17. The apparatus as in claim 11, wherein the process when executed is further configured to:
initiate a simulation of the agentic system using the execution plan.

18. The apparatus as in claim 11, wherein the apparatus uses the path in the reverse direction from the source node to the sink node as the execution plan for the agentic system to complete the task by:
using the path in the reverse direction to generate an executable script for execution by the agentic system.

19. The apparatus as in claim 18, wherein the agentic system uses the executable script to address a subsequent request to perform the task again.

20. A tangible, non-transitory, computer-readable medium storing program instructions that cause a device to execute a process comprising:
receiving, at the device, a request for an agentic system comprising a plurality of artificial intelligence agents to complete a task;
representing, by the device, the task as a sink node in a graph and contextual information from the request as a source node in the graph;
identifying, by the device, a path in the graph from the sink node to the source node in part by recursively adding action nodes to the graph that represent potential actions that the agentic system could take; and
using, by the device, the path in a reverse direction from the source node to the sink node as an execution plan for the agentic system to complete the task.
